(19) United States
(12) Patent Application Publication
(10) Pub. No.: US 2020/0016684 A1
(43) Pub. Date: Jan. 16, 2020

(54) Ultrasonic Machine Tool Comprising Two Sonotrodes and Method for Operating Same

(71) Applicant: Herrmann Ultraschalltechnik GmbH & Co. KG, Karlsbad (DE)

(72) Inventor: Gerhard Gnad, Keltern (DE)

(21) Appl. No.: 16/478,299

(22) PCT Filed: Mar. 28, 2018
(86) PCT No.: PCT/EP2018/057993

§ 371 Date: Jul. 16, 2019

(30) Foreign Application Priority Data
Apr. 3, 2017 (DE) 10 2017 107 151.2

(51) Int. Cl. B23K 20/10; B06B 1/02

(52) U.S. Cl. CPC B23K 20/10; B06B 2201/40; B06B 2201/72; B06B 1/0276

(57) ABSTRACT

The present invention relates to an ultrasonic machine tool comprising a first sonotrode (2) with a first resonant frequency f₁, a first converter (4) which is connected to the first sonotrode (2), and a generator (1) with a generator output for generating a first electrical alternating voltage with the first frequency f₁ and for outputting the first electrical alternating voltage at the generator output, the generator output being connected to the first converter (4). According to the invention, a second sonotrode (3) with a second resonant frequency h and a second converter (5) which is connected to the second sonotrode (3) are provided, wherein the generator output is connected to the second converter (5) and the generator (1) is designed to produce a mix signal which has the first electrical alternating voltage and a second electrical alternating voltage with the second frequency h, and to output the mix signal at the generator output, and wherein the first frequency f₁ and the second frequency f₂ differ from one another.

The present invention relates to an ultrasonic machine tool comprising a first sonotrode with a first resonant frequency f₁, and a first converter which is connected to the first sonotrode. Furthermore, the ultrasonic machine tool has a generator with a generator output for generating a first electrical alternating voltage with the first frequency f₁ or substantially with the first frequency f₁ and for outputting the first electrical alternating voltage at the generator output, wherein the generator output is connected to the first converter.

Such ultrasonic machine tools are known in principle. They are used for ultrasonic welding or ultrasonic cutting, for example. The sonotrode is equipped with a welding or cutting surface and is acted upon by ultrasonic vibration and, for welding or cutting, usually moved towards a counter tool, with the result that the material to be welded or to be cut is guided between the sonotrode on the one hand and the counter tool on the other hand.

In order to set the sonotrode vibrating, it is optionally connected to a converter via an amplitude transformer. The converter converts the electrical alternating voltage applied thereto into a mechanical vibration. The optionally interconnected amplitude transformer alters the amplitude, but without changing the frequency of the vibration. A generator which generates an electrical alternating voltage is connected to the converter. In order to transfer a significant amount of energy from the sonotrode to the workpiece to be machined, it is necessary for the ultrasonic vibration unit, which consists of the converter, the sonotrode and optionally the amplitude transformer, to be excited with the resonant frequency relevant for welding, with the result that a standing ultrasonic wave forms within the ultrasonic vibration unit. The generator is therefore adapted to the ultrasonic vibration system, with the result that it provides the alternating voltage with the desired resonant frequency. In some application cases, however, it is desired that the generator generates a frequency which is in the immediate vicinity of the resonant frequency of the ultrasonic vibration unit but does not correspond exactly to the resonant frequency.

The electrical alternating voltage is therefore always tuned to the resonant frequency of the ultrasonic vibration system or the sonotrode.

The provision of a single sonotrode is often not sufficient to machine the material completely. There are therefore application cases in which two or even more sonotrodes are in use. As a rule, each sonotrode is supplied with its own generator, which provides the corresponding electrical alternating voltage signal at the generator output.

Isolated attempts have already been made to operate more than one sonotrode with a common generator. In that case, either sonotrodes with the same resonant frequency were used, with the result that these could be excited simultaneously, or the generator output was connected to the different sonotrodes successively, with the result that, although the generator could excite several sonotrodes, only one sonotrode was ever excited at any point in time.

In the first case there is no possibility of varying the vibration amplitudes of the individual sonotrodes separately. In the second case simultaneous operation of several sonotrodes with one generator is not possible.

Starting from the described state of the art, an objective of the present invention is to provide an ultrasonic machine tool of the type mentioned at the outset, which cost-effectively allows the operation of a further sonotrode. Another objective of the present invention is to specify a method for operating two sonotrodes.

With regard to the ultrasonic machine tool this objective is achieved in that a second sonotrode with a second resonant frequency f₂ and a second converter, which is connected to the second sonotrode, are provided, wherein the generator output is also connected to the second converter, and the generator is formed such that it generates a mixed signal, which has the first electrical alternating voltage and a second electrical alternating voltage with the second frequency f₂ or substantially with the second frequency f₂, and outputs the mixed signal at the generator output, and wherein the first frequency f₁ and the second frequency f₂ differ from one another.

The mixed signal generated can be, for example, the sum of the first electrical alternating voltage and the second electrical alternating voltage. The summed mixed signal is now supplied to both ultrasonic vibration units each consisting of a sonotrode and a converter.

The invention is based on the observation that any ultrasonic vibration system substantially only takes up electrical energy which is provided in the form of alternating voltage with the suitable frequency. The proportion of the mixed signal which is provided with a frequency which differs sufficiently from the resonant frequency of the sonotrode to be excited does not contribute to the excitation.

The mixed signal is thus made available to all the sonotrodes wherein, however, only the part of the mixed signal with the suitable resonant frequency contributes to the excitation.

It is therefore possible, by changing the proportions or amplitudes of the first and second electrical alternating voltage, to increase or decrease the vibration amplitude of the first and second sonotrode separately from each other.

In a particularly preferred embodiment, the difference between the first frequency f₁ and the second frequency f₂ is greater than 300 Hz, preferably greater than 500 Hz and ideally greater than 1000 Hz.

As already explained at the start, as a rule, ultrasonic vibration systems do not display a sharp resonant frequency, with the result that it is possible to also excite the sonotrode with an alternating voltage, the frequency of which differs slightly from the resonant frequency.

In order to ensure that also only the first sonotrode is excited with the first electrical alternating voltage and that also only the second sonotrode is excited with the second electrical alternating voltage, the first frequency f₁ and the second frequency f₂ should therefore differ sufficiently from one another. In addition, during machining, i.e. when the sonotrode comes into contact with the material to be machined, a change, namely usually an increase, inevitably occurs in the resonant frequency due to the damping and the coupling to the material to be machined. The resonant frequencies are to be selected such that even in the case of a resonant frequency shift brought about by the damping in the case of one sonotrode the two resonant frequencies still differ from one another.

In a further preferred embodiment a first ammeter is provided for measuring the current flowing through the first converter and a second ammeter is provided for measuring the current flowing through the second converter.

Based on the current flowing through the converter, a conclusion can be drawn regarding the vibration amplitude of the sonotrode. For example a coil can be connected in parallel with the converter and dimensioned such that it forms a trap circuit with the capacity of the converter at the resonant frequency. The current through the converter for sinusoidal excitations is then proportional to the vibration amplitude of the sonotrode.

In an alternative embodiment the coil can be dispensed with, if the alternating voltage U_{E}(t) applied to the converter and the current flowing through the converter I_{E}(t) are measured and the vibration amplitude of the sonotrode or a field size of the electrical vibration system consisting of the generator and the converter related to the vibration amplitude is calculated therefrom.

Due to the fact that the vibration amplitude is calculated from the measured current and the measured voltage, the parallel connection of a coil can be dispensed with. This leads not only to a simplification of the generator, but also makes it possible for the generator to be able to be used for different ultrasonic vibration systems which are to be excited with different natural frequencies. In the case of the known generators only a very limited adjustability of the excitation frequency is possible, as the excitation frequency must always approximately correspond to the resonant frequency of the oscillating circuit formed by the coil connected in parallel and the converter capacity.

This limitation does not apply in the case of the method described, as the vibration amplitude of the sonotrode is now calculated. This method is described in detail in WO2013/017452, the content of which is incorporated by reference.

Particularly preferably, a first controller is provided which, on the basis of the current flowing through the first converter, determines the ACTUAL vibration amplitude of the first sonotrode and, in the case of a difference between the ACTUAL vibration amplitude determined and a predetermined TARGET vibration amplitude, changes the amplitude of the first electrical alternating voltage, wherein a second controller is also particularly preferably provided which, on the basis of the current flowing through the second converter, determines the ACTUAL vibration amplitude of the second sonotrode and, in the case of a difference between the ACTUAL vibration amplitude determined and a predetermined TARGET vibration amplitude, changes the amplitude of the second electrical alternating voltage.

This measure makes it possible to regulate the vibration amplitude of each ultrasonic vibration system independently of the vibration amplitudes of the other sonotrode.

The present invention also relates to a method for simultaneously operating a first ultrasonic vibration unit consisting of a first converter and a first sonotrode with a resonant frequency f₁ and a second ultrasonic vibration unit consisting of a second converter and a second sonotrode with a resonant frequency f₂.

The objective named at the start is achieved by the steps:
a) providing the first and second ultrasonic vibration units,
b) providing a generator with a generator output,
c) connecting the generator output to a signal input of the first converter and to a signal input of the second converter,
d) generating a mixed signal consisting of a first electrical alternating voltage with the first frequency f₁ or with substantially the first frequency f₁ and a second electrical alternating voltage with the second frequency f₂ or with substantially the second frequency f₂,
e) outputting the mixed signal at the generator output

The second resonant frequency f₂ is preferably selected at least 1%, better at least 2% greater than the first resonant frequency f₁. Alternatively the second resonant frequency f₂ can be selected at least 200 Hz, better at least 400 Hz greater than the first resonant frequency f₁.

The mixed signal is preferably the sum of the first electrical alternating voltage and the second electrical alternating voltage.

In a preferred embodiment the current I₁ through the first converter and/or the current I₂ through the second converter is measured.

Furthermore, the ACTUAL vibration amplitude of the first sonotrode can be calculated from the current I₁ through the first converter and the amplitude U₁ of the first electrical alternating voltage. The ACTUAL vibration amplitude of the second sonotrode is preferably calculated from the current I₂ through the second converter and the amplitude U₂ of the second electrical alternating voltage.

The vibration amplitude of the first sonotrode is preferably controlled, wherein the first amplitude U₁ of the first alternating voltage is used as control variable, wherein the vibration amplitude of the second sonotrode is preferably also controlled, wherein the second amplitude U₂ of the second alternating voltage is used as control variable for this.

Further advantages, features and possible applications of the present invention become clear with reference to the following description of a preferred embodiment as well as the associated figure. There is shown in:

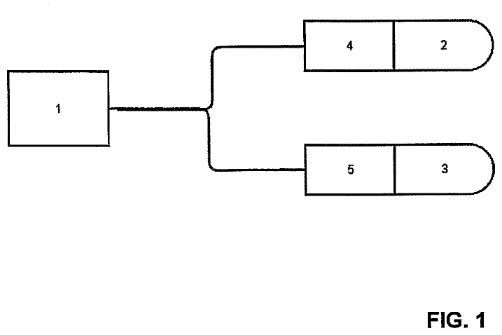

FIG. 1 a schematic representation of a preferred embodiment of the invention.

FIG. 1 shows a schematic representation of an ultrasonic machine tool. The ultrasonic machine tool has a first sonotrode 2 and a second sonotrode 3.

The first sonotrode 2 is connected to a first converter 4. An amplitude transformer could be arranged between first sonotrode 2 and first converter 4. The converter 4 converts the electrical alternating voltage applied at its input into a mechanical vibration. The ultrasonic vibration system consisting of the first sonotrode 2 and the first converter 4 has a first resonant frequency. If an electrical alternating voltage with the resonant frequency or a frequency which differs slightly from the resonant frequency is applied at the input of the converter 4, the first ultrasonic vibration unit is set vibrating and the sonotrode 2 can be used for machining a material.

The second sonotrode 3 is connected to a second converter 5. The first ultrasonic vibration unit with the first sonotrode 2 and the first converter 4 is constructed just like the second ultrasonic vibration unit consisting of the second sonotrode 3 and the second converter 5, wherein the resonant frequencies of the two ultrasonic vibration systems differ from one another.

Furthermore, a generator 1 is provided, which provides a signal at an output, which signal is connected both to the first converter 4 and to the second converter 5.

The generator 1 generates a mixed frequency which is composed of the sum of the individual electrical alternating voltages for the individual ultrasonic vibration systems. In the example shown, the mixed frequency is therefore the sum of the first electrical alternating voltage for driving the first sonotrode 2 and the second electrical alternating voltage for exciting the second sonotrode 3.

The mixed frequency generated by the generator 1 is supplied to a power stage integrated in the generator. The power stage can be a digital power stage, which outputs the corresponding mixed frequency and supplies it to the two converters 4 and 5.

The high-frequency currents are measured by means of so-called ammeters. The amplitude of the connected system can be ascertained from the measured currents via a calculation method. The ACTUAL amplitudes ascertained in this way are each supplied to one controller and the frequency and/or the voltage are correspondingly controlled. The corresponding calculation method is for example described in WO 2013/017452.

### LIST OF REFERENCE NUMBERS

1 generator

2, 3 sonotrode

4, 5 converter

1. Ultrasonic machine tool comprising a first sonotrode (2) with a first resonant frequency f₁, a first converter (4), which is connected to the first sonotrode (2), and a generator (1) with a generator output for generating a first electrical alternating voltage with the first frequency f₁ and for outputting the first electrical alternating voltage at the generator output, wherein the generator output is connected to the first converter (4), characterized in that a second sonotrode (3) with a second resonant frequency f₂ and a second converter (5), which is connected to the second sonotrode (3), are provided, wherein the generator output is connected to the second converter (5), and the generator (1) is formed so as to generate a mixed signal which has the first electrical alternating voltage and a second electrical alternating voltage with the second frequency f₂, and to output the mixed signal at the generator output, and wherein the first frequency f₁ and the second frequency f₂ differ from one another.

2. Ultrasonic machine tool according to claim 1, characterized in that the difference between the first frequency f₁ and the second frequency f₂ is greater than 300 Hz.

3. Ultrasonic machine tool according to claim 1, characterized in that a first ammeter is provided for measuring the current flowing through the first converter (4) and a second ammeter is provided for measuring the current flowing through the second converter (5).

4. Ultrasonic machine tool according to claim 3, characterized in that a first controller is provided which, on the basis of the current flowing through the first converter (4), determines the ACTUAL vibration amplitude of the first sonotrode (2) and, in the case of a difference between the ACTUAL vibration amplitude determined and a predetermined TARGET vibration amplitude, changes the amplitude of the first electrical alternating voltage.

5. Method for simultaneously operating a first ultrasonic vibration unit consisting of a first converter (4) and a first sonotrode (2) with a resonant frequency f₁ and a second ultrasonic vibration unit consisting of a second converter (5) and a second sonotrode (3) with a resonant frequency f₂, characterized by the steps:
a) providing the first and second ultrasonic vibration units,
b) providing a generator (1) with a generator output,
c) connecting the generator output to a signal input of the first converter (4) and to a signal input of the second converter (5),
d) generating a mixed signal consisting of a first electrical alternating voltage with the first frequency f₁ and a second electrical alternating voltage with the second frequency f₂,
e) outputting the mixed signal at the generator output.

6. Method according to claim 5, characterized in that the second resonant frequency f₂ is selected at least 1% greater than the first resonant frequency f₁.

7. Method according to claim 5, characterized in that the mixed signal is the sum of the first electrical alternating voltage and the second electrical alternating voltage.

8. Method according to claim 7, characterized in that the current I₁ through the first converter (4) and/or the current I₂ through the second converter (5) is measured.

9. Method according to claim 8, characterized in that the ACTUAL vibration amplitude of the first sonotrode (2) is calculated from the current I₁ through the first converter (4) and the amplitude U₁ of the first electrical alternating voltage.

10. Method according to claim 9, characterized in that the vibration amplitude of the first sonotrode (2) is controlled, wherein the first amplitude U₁ of the first alternating voltage is used as control variable.

11. Ultrasonic machine tool according to claim 2, characterized in that the difference between the first frequency f₁ and the second frequency f₂ is greater than 500 Hz.

12. Ultrasonic machine tool according to claim 11, characterized in that the difference between the first frequency f₁ and the second frequency f₂ is greater than 1000 Hz.

13. Ultrasonic machine tool according to claim 4 wherein a second controller is preferably provided which, on the basis of the current flowing through the second converter (5), determines the ACTUAL vibration amplitude of the second sonotrode (3) and, in the case of a difference between the ACTUAL vibration amplitude determined and a predetermined TARGET vibration amplitude, changes the amplitude of the second electrical alternating voltage.

14. Method according to claim 6, characterized in that the second resonant frequency f₂ is selected at least 2% greater than the first resonant frequency f₁.

15. Method according to claim 9, wherein the ACTUAL vibration amplitude of the second sonotrode (3) is preferably also calculated from the current I₂ through the first converter (4) and the amplitude U₂ of the first electrical alternating voltage.

16. Method according to claim 10 wherein the vibration amplitude of the second sonotrode (3) is preferably also controlled, wherein the second amplitude U₂ of the second alternating voltage is used as control variable.
